(19) United States
(12) Patent Application Publication
(10) Pub. No.: US 2023/0370823 A1
(43) Pub. Date: Nov. 16, 2023

(54) NETWORK CAPABILITY EXPOSURE METHOD, DEVICE, AND STORAGE MEDIUM

(71) Applicant: ZTE Corporation, Shenzhen, Guangdong (CN)

(72) Inventor: Qiang Huang, Shenzhen (CN)

(73) Assignee: ZTE Corporation, Shenzhen, Guangdong (CN)

(21) Appl. No.: 18/025,996

(22) PCT Filed: Aug. 5, 2021
(86) PCT No.: PCT/CN2021/110919

§ 371 Date: Mar. 13, 2023

(30) Foreign Application Priority Data
Sep. 16, 2020 (CN) 202010972218.9

(51) Int. Cl. H04W 4/50; H04L 67/51; H04L 67/60

(52) U.S. Cl. CPC H04W 4/50; H04L 67/51; H04L 67/60

(57) ABSTRACT

A network capability exposure method, a device, and a storage medium are disclosed. The method may include, receiving a network capability service request from an application server, wherein the network capability service request comprises an external identifier of the application server; performing an internal identifier matching according to the external identifier in the network capability service request generating a network capability service response according to a result of the internal identifier matching; and sending the network capability service response to the application server.

### CROSS-REFERENCE TO RELATED APPLICATION

This application is a national stage filing under 35 U.S.C. § 371 of international application number PCT/CN2021/110919, filed Aug. 5, 2021, which claims priority to Chinese patent application No. 202010972218.9, filed Sep. 16, 2020. The contents of these applications are incorporated herein by reference in their entirety.

### TECHNICAL FIELD

The present disclosure relates to, but is not limited to, the technical field of communication, and in particular to a method for network capability exposure, a device, and a storage medium.

### BACKGROUND

The market potential of network capability is great in recent years, and the demand of customers is strong. The exposure and integration of communication capability become the focus of the growth of operators and the development of mobile communication networks. For example, the current 5G stage is a transformation from network enablement to service enablement, with a wider and deeper call for network capabilities and more types and ranges of network capabilities. On the other hand, the opening of network capabilities is an attempt by operators to increase revenue, thereby network capabilities are exposed to third-party applications, the service experience of third-party applications is enhanced, and new business models are realized.

In some cases, the exposure of mobile network capabilities is mainly carried out at the core network side, and the base station forwards the information from the application server to the core network side for information processing. Then the corresponding network capabilities are exposed to the application server, which will cause some network delay and resource consumption.

### SUMMARY

Provided are a method for network capability exposure, a device, and a storage medium in some embodiments of the present disclosure.

An embodiment of the present disclosure provides a method for network capability exposure, which is performed by a radio access network device, the method may include, receiving a network capability service request from an application server, where the network capability service request may include an external identifier of the application server; performing an internal identifier matching according to the external identifier in the network capability service request; generating a network capability service response according to a result of the internal identifier matching; and sending the network capability service response to the application server.

An embodiment of the present disclosure provides a method for network capability exposure, which is performed by an application server, the method may include, generating a network capability service request according to a requested network capability, where the network capability service request may include an external identifier; sending the network capability service request to a radio access network device; and receiving a network capability service response from the radio access network device, where the network capability service response is generated by an internal identifier matching according to the external identifier in the network capability service request, by the radio access network device.

An embodiment of the present disclosure provides a method for network capability exposure, which is performed by a core network device, the method may include, receiving an inquiry request from a radio access network device, where the inquiry request is generated by the radio access network device according to a network capability service request sent by an application server, and the inquiry request may include an external identifier of the application server; generating a query response according to the inquiry request, where the query response may include an internal identifier that matches the external identifier; sending the query response to the radio access network device, such that the radio access network device generates a network capability service response according to the query response and sends the network capability service response to the application server.

An embodiment of the present disclosure provides a radio access network device, which may include, a first receiving module, which is configured to receive a network capability service request from an application server, where the network capability service request may include an external identifier; a matching module, which is configured to perform an internal identifier matching according to the external identifier in the network capability service request; a first generating module, which is configured to generate a network capability service response according to a result of the internal identifier matching; and a first sending module, which is configured to send the network capability service response to the application server.

An embodiment of the present disclosure provides an application server, which may include, a second generating module, which is configured to generate a network capability service request according to a requested network capability, and the network capability service request may include an external identifier; a second sending module, which is configured to send a network capability service request to a radio access network device; and a second receiving module, which is configured to receive a network capability service response from the radio access network device; where the network capability service response is generated by the radio access network device through performing an internal identifier matching according to the external identifier in the network capability service request.

An embodiment of the present disclosure provides a core network device, which may include, a third receiving module, which is configured to receive an inquiry request from a radio access network device, where the inquiry request is generated by the radio access network device according to a network capability service request sent by an application server, and the inquiry request may include an external identifier of the application server; a third generating module, which is configured to generate a query response according to the inquiry request, where the query response may include an internal identifier that matches the external identifier; and a third sending module, which is configured to send the query response to the radio access network device, such that the radio access network device generates a network capability service response according to the query response and sends the network capability service response to the application server.

An embodiment of the present disclosure provides an electronic device, which may include a processor and a memory storing thereon a processor-executable computer program which, when executed by the processor, causes the processor to carry out any one of the methods as described above.

An embodiment of the present disclosure provides a computer-readable storage medium storing thereon a computer-executable instruction which, when executed by the computer, causes a processor of the computer to carry out any one of the methods as described above.

Other features and advantages of the present disclosure will be illustrated in the following description, and in part will be apparent from the description, or may be understood by practicing the present disclosure. The objects and other advantages of the present disclosure can be achieved and obtained by the structure particularly set forth in the description, claims and drawings.

### BRIEF DESCRIPTION OF DRAWINGS

FIG. 1 depicts a system architecture diagram related to a method for network capability exposure according to an embodiment of the present disclosure;

FIG. 2 depicts another system architecture diagram related to a method for network capability exposure according to an embodiment of the present disclosure;

FIG. 3 depicts a flow diagram of a method for network capability exposure according to an embodiment of the present disclosure;

FIG. 4 depicts a flow diagram of S1300 of the method for network capability exposure according to an embodiment of the present disclosure;

FIG. 5 depicts another flow diagram of a method for network capability exposure according to an embodiment of the present disclosure;

FIG. 6 depicts an implementation of a method for network capability exposure according to an embodiment of the present disclosure;

FIG. 7 depicts another implementation of the method for network capability exposure according to an embodiment of the present application;

FIG. 8 depicts yet another implementation of the method for network capability exposure according to an embodiment of the present application;

FIG. 9 depicts yet another flow diagram of a method for network capability exposure according to an embodiment of the present disclosure;

FIG. 10 depicts yet another flow diagram of a method for network capability exposure according to an embodiment of the present disclosure;

FIG. 11 depicts a schematic diagram showing a radio access network device according to an embodiment of the present disclosure;

FIG. 12 depicts another schematic diagram showing a radio access network device according to an embodiment of the present disclosure;

FIG. 13 depicts a schematic diagram showing an application server according to an embodiment of the present disclosure;

FIG. 14 depicts a schematic diagram showing a core network device according to an embodiment of the present disclosure; and

FIG. 15 depicts a schematic diagram showing an electronic device according to an embodiment of the present disclosure.

### DETAILED DESCRIPTION

The purpose, technical scheme and advantages of the present disclosure will become apparent through the following description for various embodiments in conjunction with the drawings. It should be understood that the embodiments described here are intended for illustration but not limitation of the present disclosure. The embodiments of the present disclosure and the features in the embodiments can be combined with each other without conflict.

It should be noted that although the devices are shown with individual functional modules in the schematic diagram and the logical sequences are shown in the flow chart, in some cases, the devices can have different modules than those shown and the steps can be executed in a different order than those shown. It should be noted that the terms “first” and “second”, if used in the description and the drawings are intended to distinguish similar objects, and do not necessarily imply any specific order or sequence. The term “several”, if mentioned, means more than one. The term “multiple”, if mentioned means more than two. The term “below”, if mentioned should be understood as including this number indicated by the term.

The market potential of network capability is great in recent years, and the demand of customers is strong. The exposure and integration of communication capability become the focus of the growth of operators and the development of 5G networks. The current 5G stage is a transformation from network enablement to service enablement, with a wider and deeper call for network capabilities and more types and ranges of network capabilities. On the other hand, the opening of network capabilities is an attempt by operators to increase revenue, thereby network capabilities are exposed to third-party applications, the service experience of third-party applications is enhanced, and new business models are realized.

The existing mobile network capability exposure is mainly carried out at the core network side. The base station forwards the information from the application server to the core network side for information processing. Then the corresponding network capability is exposed to the application server. However, the existing mobile network capability exposure does not directly expose the User Equipment (UE) level network capability service at the radio access network side, so there will be some network delay and resource consumption during the network capability exposure at the core network side.

It should be noted that the network capability exposure refers to the procedure in which, a third-party authentication is performed, acquisition of mobile network capability is acquired, aggregation and arrangement are performed, and northbound capability exposure application programming interface (API) is provided to the third party, i.e., the application server, and the north-south interface conversion is performed. Network capabilities include query capabilities and control capabilities. Examples of query capabilities include the acquisition of the user location, cell status and online status of users, while examples of control capabilities include the setting of the Quality of Service (QoS) required by services.

In Long Term Evolution (LTE) networks, the core network side refers to the Mobility Management Entity (MME), Serving Gateway (S-GW), and Packet Data Network Gateway (P-GW). In the Universal Mobile Telecommunication System (UMTS) networks, the core network side refers to Support GPRS Serving Node (SGSN) and Gateway GPRS Support Node (GGSN). The core network side enhances the GGSN/P-GW in the capability exposure architecture, and reports the cell location and cell status of User Equipment (UE) to the capability exposure gateway.

The radio access network side refers to evolved Node B (eNodeB) in LTE networks and Radio Network Controller (RNC) and NodeB in UMTS networks. The radio access network side enhances the eNodeB and RNC in the capability exposure architecture, and reports the cell position and cell state of the UE to the wireless core network through the user plane.

The application server is a high-performance computer in the network, which provides services for terminal devices of various types (including computers) connected thereto, and which is equivalent to the control center and service center of the network. The performance of the server plays a key role in the performance of the network. The server is required to have good performance in data processing and large-flow data access reception. The server should have high stability and reliability, perfect system functions and can ensure data security. The application server initiates a request to the core network side to expose related network capabilities. For example, when trying to acquire the location information of the terminal device, an advertising company has to initiate a request to the core network side to expose the location information of the terminal device through the application server, so that the query result of the location information can be received at the application server. The network device can be a device for communicating with the application server, and the network device can include a base station, a repeater or other network-side devices with similar functions. In the following embodiments, only the base station is taken by way of example for illustration.

In view of the foregoing, some embodiments of the present disclosure provide a method for network capability exposure, a device and a storage medium, through which network capability exposure can be realized at the radio access network side rather than at the core network side, thereby saving network delay and signaling overhead and reducing the consumption of broadband resources.

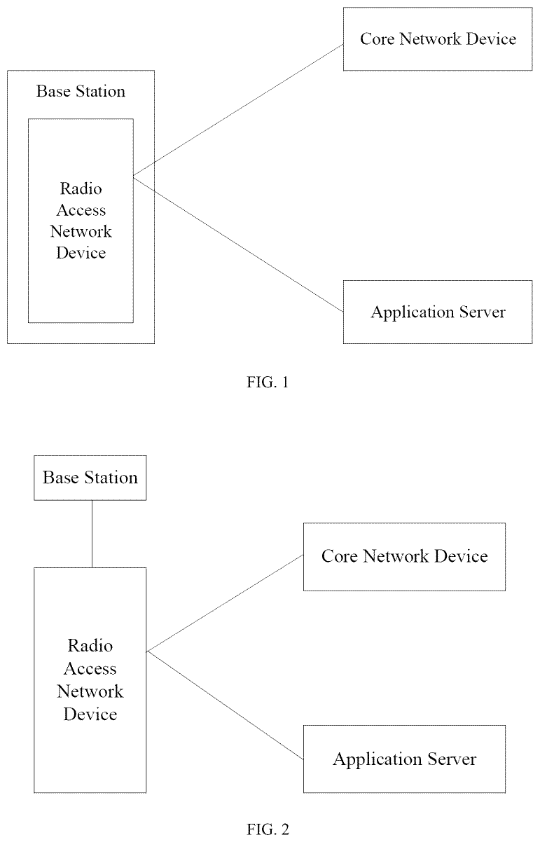

It should be noted that the system architecture in which the method for network capability exposure in an embodiment of the present application is carried out, is shown in FIG. 1 or FIG. 2. The radio access network device is deployed at the radio access network side, and performs related functions of the radio access network device through modularization. The core network device is deployed at the core network side, and performs the related functions of the core network device through modularization. In the system architecture shown in FIG. 1, the radio access network device and the base station are co-located. Alternatively, as shown in FIG. 2, the radio access network device and the base station are separately deployed and communicatively connected. And the radio access network device is communicatively connected with the core network device and the application server respectively to receive, process and forward relevant signal instructions.

An embodiment of the present application provides a method for network capability exposure, which is performed by a radio access network device.

In some embodiments, a network capability service request is received from an application server, where the network capability service request includes an external identifier of the application server. Then, an internal identifier matching is performed according to the external identifier of the network capability service request, and a network capability service response is generated according to the result of the internal identifier matching. Then the network capability service response is sent to the application server to achieve network capability exposure. Thereby, network capability exposure can be directly realized on the radio access network side rather than on the core network side, thus decreasing network delay and signaling overhead, and reducing the consumption of broadband resources.

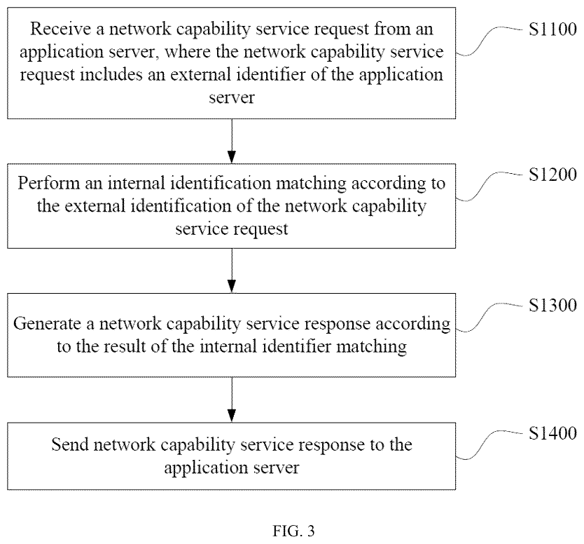

In some embodiments, referring to FIG. 3, the method for network capability exposure performed by the radio access network device in an embodiment of the present application includes the following operations.

At S1100, a network capability service request is received from an application server, where the network capability service request includes an external identifier of the application server.

At S1200, internal identification matching is performed according to the external identification of the network capability service request.

At S1300, a network capability service response is generated according to the result of the internal identifier matching.

At S1400, a network capability service response is sent to the application server.

At S1100, a radio access network device deployed on the wireless access network side receives a network capability service request generated from an application server. The network capability service request is generated by the application server according to the network capability requested by the practical demands and is configured to request the radio access network device to expose related network capabilities. The network capability service request includes an external identifier corresponding to the application server, which serves as the identity identifier of the application server, so that the radio access network device can perform identity identification by the acquired external identifier of the network capability service request. It should be noted that the system architecture corresponding to this embodiment of the present application is as shown in FIG. 1. The radio access network device and the base station are co-located, and no communication interface is required for connection therebetween.

At S1200, after receiving the network capability service request from the application server, the radio access network device identifies the network capability service request to acquire the external identifier from the network capability service request, and performs matching with each internal identifier according to the acquired external identifier to determine whether the external identifier can match an internal identifier. In this way, the network capability exposure is performed according to the matched internal identifier.

At S1300, the radio access network device generates a corresponding network capability service response according to the result of the internal identifier matching. If the network capability exposure is carried out, the network capability service response includes a network capability resource response, an external identifier and an indicator code. The network capability resource response refers to the result of the network capability exposure generated after the network capability requested by the application server is exposed, which is configured to inform the application server of the result of the request. The external identifier is the external identifier carried in the network capability service request sent by the application server. The indicator code is configured to notify the application server whether the network capability service request will lead to the performance of the network capability exposure. For example, when the indicator code is 200, it indicates that the network capability exposure is successfully carried out.

In some embodiments, the network capability service request further includes an application identifier and a network capability identifier, where the application identifier is configured to identify the application server, and the application server is identified by a specific device Identity document (ID). The network capability identifier is configured to identify the network capability requested by the application server, so that the radio access network device can identify the network capability requested by the application server.

In some embodiments, network capabilities include one or more of the following, location service capabilities, wireless network information service capabilities, wireless bandwidth management service capabilities, and the like. The location service capability refers to the network capability of the positioning of application servers in an indoor environment with a base station for positioning. Wireless network information service capability refers to the network capability of obtaining desired wireless network information by means of inquiry or subscription, in which the types of wireless network information include information of each cell, each application server and each QoS Class Identifier (QCI) and other parameters. Wireless bandwidth management service capability refers to the network capability to control the bandwidth required by the service, so as to improve the service quality of the service. It should be noted that the network capability identification in an embodiment of the present disclosure is not limited to the above-mentioned network capabilities, but also includes network capabilities such as service routing planning, and so on, and will not be further described here.

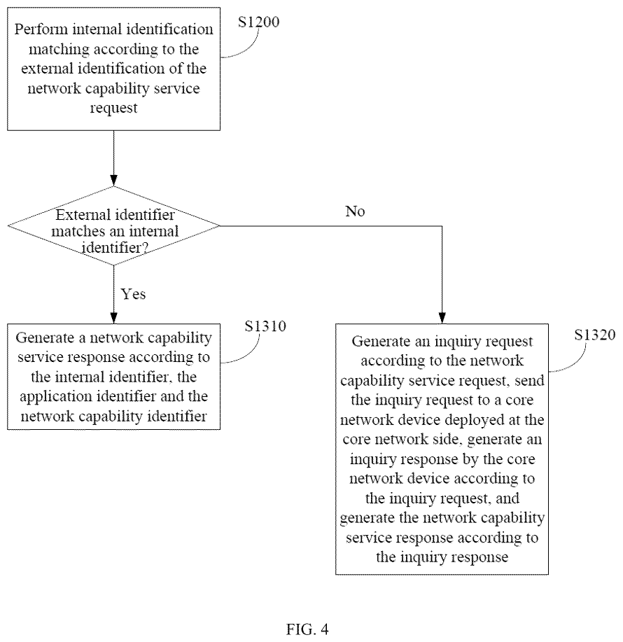

In some embodiments, referring to FIG. 4, if the external identifier matches an internal identifier at S1300, S1300 further includes the following operation.

At S1310, a network capability service response is generated according to the internal identifier, the application identifier and the network capability identifier.

At S1310, the radio access network device acquires the internal identifier matching the external identifier, and generates a network capability service response according to the acquired internal identifier, the application identifier and network capability identifier in the network capability service request. The application server which makes the request can be identified by the application identifier. The requested network capability can be identified by the network capability identifier. The requested network capability can be queried by the internal identifier to generate the result of the network capability exposure. Then the corresponding network capability service response can be generated in conjunction with the external identifier.

In some embodiments, the external identifier is an identifier used when the 5G system interacts with network elements such as external AF (Application Function), and the external identifier includes any one or more of the following: the external Internet Protocol (IP) address of UE, external port number and UE identifier. The UE identifier is the Mobile Subscriber International ISDN/PSTN Number (MSISDN) of the UE connected to the application server, which is the unique identifier of the UE.

In some embodiments, the internal identifier is an internal identifier of a network system, such as a 5G system internal identifier, and the internal identifier includes any one or more of the following: global identifier, short identifier, long identifier, interface identifier, UE internal IP address, internal port number. The global identifier can be 5G globally unique temporary UE identity (5G-GUTI) in the internal identifier of 5G system, which is intended to reduce the permanent identifier of the UE displayed in 5G communication, and can improve the communication security. The short identifier can be 5G S-Temporary Mobile Subscriber Identity (5G-S-TMSI) in the internal identifier of 5G system, which is a shortened form of 5G-GUTI, which can reduce the size of the signaling message over the air interface and improve the air interface efficiency. The long identifier can be 5G Temporary Mobile Subscriber Identity (5G-TMSI) in the internal identifier of the 5G system. The interface identifier can be the access and mobility management function (AMF) UE NG AP ID of the AMF of the 5G system, which is the identifier of the AMF in the NGAP interface, and related network capabilities can be exposed according to the identifier. The internal IP address of the UE is the IP address within the 5G system. The internal port number is the internal port number of the 5G system. Correspondingly, the internal identifier includes any one or more of the following: 5G-GUTI, 5G-S-TMSI, 5G-TMSI, AMF UE NGAP ID, internal IP address of UE, and internal port number.

In an implementation, the radio access network device finds the internal identifier corresponding to the MSISDN within the received external identifier, for example, the interface identifier, AMF UE NGAP ID in the internal identifier. Then the device exposes related network capabilities according to the interface identifier, for example, according to the calculated UE location from the interface identifier found within the base station, and generates the network capability service response with the UE location in conjunction with the external identifier.

In some embodiments, the internal identifier corresponding to the external identifier is stored in the radio access network device within a preset time. And the internal identifier will be cleared after the preset time, from the radio access network device. In the subsequent operation, if a network capability service request with the external identifier appears for the exposure of the relevant network capability and the corresponding internal identifier has been cleared, then the matching of the external identifier with the corresponding internal identifier fails. In that case, the radio access network device performs the following S1320 to acquire the corresponding internal identifier. By setting the storage time for the internal identifier, the information accuracy and real-time performance of the internal identifier in the radio access network device are ensured, so that the external identifier can match the correct internal identifier.

In some embodiments, referring to FIG. 4, if the external identifier fails to match any internal identifier at S1300, S1300 further includes the following operation.

At S1320, an inquiry request is generated according to the network capability service request, the inquiry request is sent to a core network device deployed at the core network side, a query response is generated by the core network device according to the inquiry request, and the network capability service response is generated according to the query response.

When failing to get the corresponding internal identifier according to the received external identifier by matching, the radio access network device queries the core network device deployed at the core network side to get the corresponding internal identifier. The core network device is the network device configured to perform the network functions of the core network side, which includes but is not limited to, Network Exposure Function (NEF) and the network capability operation platform of operators. NEF is located between the 5G core network and external third-party application functions, and may also have some internal AF, which is responsible for the management of the exposed data of the network. The application server has to access the internal data of the 5G core network through NEF. NEF provides external application servers with exposure of Qos customization, mobility status event subscription, and other network capabilities.

At S1320, the radio access network device generates an inquiry request according to the received network capability service request and sends the generated inquiry request to the core network device at the core network side. The inquiry request includes the external identifier of the requesting application server, and also includes a radio access network capability exposure identifier and the core network capability exposure identifier. It should be noted that the radio access network capability exposure identifier and the core network capability exposure identifier are intended for mutual identification between the radio access network device and the core network device to determine specific NEF instances. For example, if there are five NEF instances in the core network device, the radio access network device determines specific interactive NEF instances through the core network capability exposure identifier. On the other hand, the core network device also determines the specific interactive instance through the radio access network capability exposure identifier.

When receiving the inquiry request, the core network device performs an internal identifier matching with the external identifier in the inquiry request to ensure that the external identifier can match with the corresponding internal identifier according to the pre-stored identifier mapping relationship, determines the corresponding network capability according to the radio access network capability exposure identifier and the core network capability exposure identifier, and generates a query response according to the queried internal identifier, the corresponding radio access network capability exposure identifier and the core network capability exposure identifier. The query response is sent to the radio access network device.

It should be noted that the core network device stores the mapping relationship between the internal identifier and the external identifier. When acquiring the external identifier of the inquiry request, the core network device identifies the internal identifier corresponding to the external identifier according to the mapping relationship, and transfers the internal identifier to the radio access network device through the query response.

After receiving the query response, the radio access network device performs corresponding network capability exposure according to the internal identifier in the acquired query response. In some implementations, the radio access network device finds the UE location requested by the application server according to the interface identifier in the internal identifier, combines the UE location with the external identifier, and generates the network capability service response.

In some embodiments, if the external identifier fails to match the corresponding internal identifier in both the radio access network device and the core network device, it indicates that the request of the application server for network capability exposure fails. In that case, the generated network capability service response and query response include an error indicator code which is indicative of the failure of the matching of the external identifier with any internal identifier, so the application server fails to obtain the desired network capability exposure. The error indicator code may be “400” or “401” indicating a matching error.

At S1400, the radio access network device sends the generated network capability service response to the application server, so that the application server can acquire the result of the network capability exposure, for example, the current UE location.

In some embodiments, the network device is described as a base station by way of an example. And when the system architecture in the present disclosure is as shown in FIG. 2, that is, the base station and the radio access network device are deployed separately, in that case, the base station and the radio access network device communicate through a communication interface.

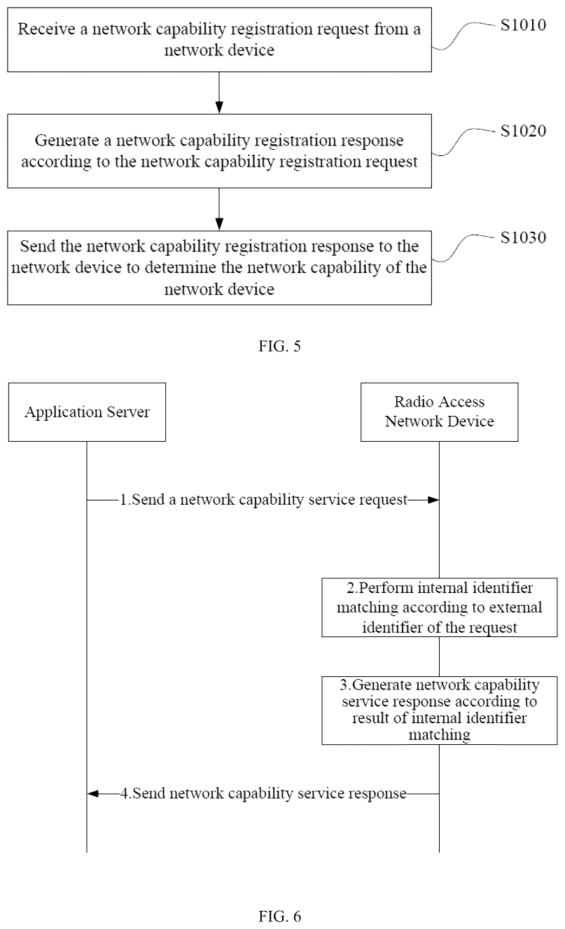

Before the method for network capability exposure in an embodiment of the present disclosure is performed, the base station initiates network capability registration to inform the radio access network device of the network capabilities owned by the base station. As shown in FIG. 5, the method for network capability exposure performed by the radio access network device in an embodiment of the present disclosure includes the following operations.

At S1010, a network capability registration request is received from a network device.

At S1020, a network capability registration response is generated according to the network capability registration request.

At S1030, the network capability registration response is sent to the network device to confirm the network capability of the network device.

At S1010, the radio access network device receives a network capability registration request from a network device, where the network capability registration request includes a device identifier of the network device, a radio access network capability exposure identifier and a network capability identifier. It should be noted that the device identifier is intended to identify the identity of the network device, that is, to confirm the information of the base station, so that the radio access network device can confirm the information of the base station. The radio access network capability exposure identifier is intended to determine the radio access network device that is to accept the network capability registration request, so as to inform the network capability that can be exposed. The network capability identifier is intended to identify the exposed network capabilities, such as location service capability, radio network information service capability, wireless bandwidth management service capability, etc.

At S1020, the radio access network device generates a network capability registration response according to the received capability registration request, where the network capability registration response includes a response indicator code, a device identifier, a radio access network capability exposure identifier and a network capability identifier. The device identifier, radio access network capability exposure identifier and network capability identifier are consistent and identical with those in the network capability registration request. The response indicator code is intended to inform the network device whether the owned network capabilities are determined. For example, when the response indicator code is “200”, it indicates that the radio access network device succeeds to determine the network capabilities owned by the network device. Alternatively, when the response indicator code is “400” or “401”, it indicates that the radio access network device fails to determine the network capabilities owned by the network device.

At S1030, the radio access network device sends the generated network capability registration response to the network device to confirm the network capability of the network device, thus completing the whole network capability registration process. If the response indicator in the returned network capability registration response indicates that the radio access network device fails to determine the network capability owned by the network device, the network device resends the network capability registration request to the radio access network device to re-register the network capabilities.

According to an embodiment of the present application, the radio access network device is enabled to acquire the exposed network capabilities of the network device. As such, the failure in the desired network capabilities exposure in response to the related network capability exposure request due to the failure of the network capability registration, is avoided.

As shown in FIG. 6, in an implementation where the system architecture as shown in FIG. 1 is adopted, the application server generates a network capability service request according to the requested network capability and sends the request to the radio access network device. The radio access network device performs an internal identifier matching with the external identifier of the network capability service request. If the external identifier matches an internal identifier, the radio access network device generates a network capability service response according to the result of the internal identifier matching and sends the response to the application server, so that the application server can acquire the result of the network capability exposure.

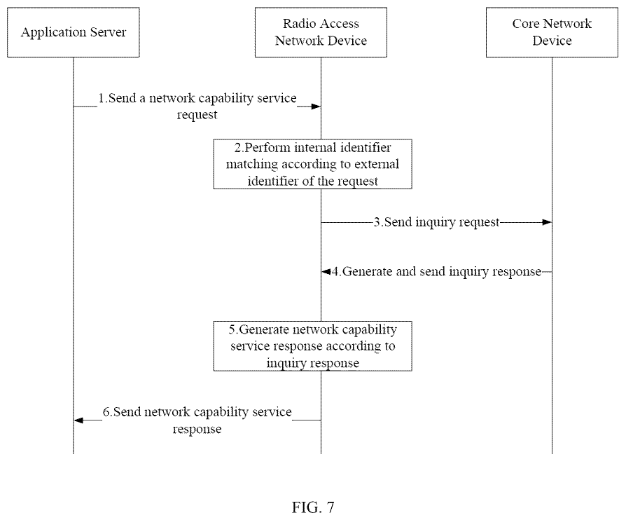

In an implementation, as shown in FIG. 7, when the radio access network device fails to acquire the corresponding internal identifier according to the matching with the external identifier of the network capability service request, the application server generates the network capability service request according to the requested network capability and sends the request to the radio access network device. The radio access network device performs the internal identifier matching according to the external identifier of the network capability service request. If the external identifier fails to match any internal identifier, then the radio access network device sends an inquiry request to the core network device. The core network device generates an inquiry response according to the inquiry request and sends the inquiry response to the radio access network device. The radio access network device generates a network capability service response according to the internal identifier in the inquiry response and sends the network capability service response to the application server, so that the application server can obtain the result of the network capability exposure.

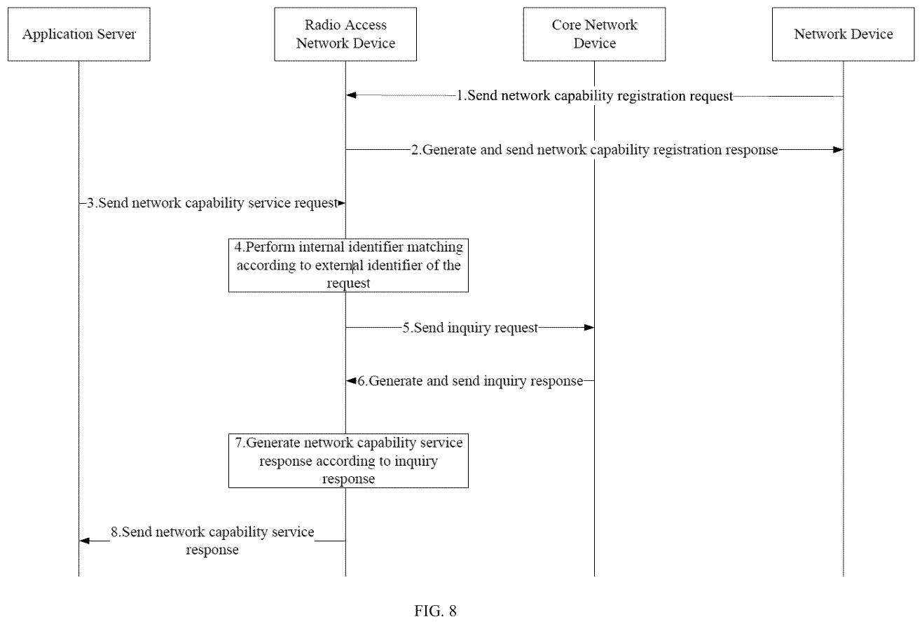

As shown in FIG. 8, in an implementation where the system architecture shown in FIG. 2 is adopted, the network device, i.e., the base station generates a network capability registration request according to its own network capability and sends the network capability registration request to the radio access network device. The radio access network device generates a network capability registration response according to the network capability registration request; and sends the response to the base station to confirm the network capability to be exposed by the base station. After that, the application server generates a network capability service request according to the requested network capability and sends the request to the radio access network device. The radio access network device performs an internal identifier matching according to the external identifier of the network capability service request. If the external identifier fails to match any internal identifier, the radio access network device sends an inquiry request to the core network device. The core network device generates an inquiry response according to the inquiry request and sends the response to the radio access network device. The radio network device generates a network capability service response according to the internal identifier in the inquiry response and sends the network capability service response to the application server, so that the application server can obtain the result of the network capability exposure.

An embodiment of the present disclosure provides a method for network capability exposure, which is performed by the radio access network device, in which, a network capability service request is received from an application server, where the network capability service request includes an external identifier of the application server. Then, an internal identifier matching is performed according to the external identifier of the network capability service request, and a network capability service response is generated according to the result of the internal identifier matching. Then the network capability service response is sent to the application server to achieve network capability exposure. Thereby, network capability exposure can be directly realized on the radio access network side rather than on the core network side, thus decreasing the network delay and signaling overhead, and reducing the consumption of broadband resources.

Another embodiment of the present application provides a method for network capability exposure, which is performed by an application server.

In some embodiments, a network capability service request is generated according to the requested network capability, where the network capability service request includes an external identifier of the application server. Then the network capability service request is sent to the radio access network device, and a network capability service response is received from the wireless access network to realize network capability exposure, where the network capability service response is generated by the radio access network device through an internal identifier matching with the external identifier of the network capability service request. Thereby, the network capability exposure can be directly realized at the radio access network side, rather than at the core network side, thus decreasing the network delay and signaling overhead and reducing the consumption of the broadband resources.

In some embodiments, referring to FIG. 9, the method for network capability exposure performed by the application server in an embodiment of the present disclosure includes the following operations.

At S2100, a network capability service request is generated according to the requested network capability, where the network capability service request includes an external identifier.

At S2200, the network capability service request is sent to a radio access network device.

At S2300, a network capability service response is received from the radio access network device, where the network capability service response is generated by an internal identifier matching with the external identifier of the network capability service request, by the radio access network device.

The application server generates the network capability service request according to the actual network capability request, to request the radio access network device to expose the associated network capability. The network capability service request includes the external identifier corresponding to the application server, which serves as the identity identifier of the application server, so that the radio access network device can identify the identity of the application server by the external identifier of the network capability service request. The network capability service request is illustrated in detail in the network capability service request described in the embodiment described above, and which will not be repeated here.

At S2200, the application server sends the generated network capability service request to the radio access network device deployed at the wireless access network side to acquire the result of the requested network capability exposure.

At S2300, the application server receives the network capability service response from the radio access network device, and the radio access network device generates the corresponding network capability service response according to the result of the internal identifier matching. If the network capability exposure is carried out, the network capability service response includes a network capability resource response, an external identifier and an indicator code. The network capability resource response refers to the result of the network capability exposure generated after the network capability requested by the application server is exposed, which is configured to inform the application server of the result of the request. The external identifier is the external identifier carried in the network capability service request sent by the application server. The indicator code is configured to notify the application server whether the network capability service request will lead to the performance of the network capability exposure. For example, when the indicator code is 200, it indicates that the network capability exposure is successfully carried out. The application server can acquire the result of related network capability exposure according to the network capability service response.

It should be noted that after receiving the network capability service request from the application server, the radio access network device deployed on the wireless access network side generates the corresponding network capability service response according to the network capability service request from the application server. The procedure of the generation is discussed in detail in the method for network capability exposure performed by the radio access network device in the embodiment related to the method for network capability exposure performed by the radio access network device, and which will not be repeated here.

An embodiment of the present disclosure provides a method for network capability, which is performed by an application server, in which a network capability service request is generated according to the requested network capability, where the network capability service request includes an external identifier of the application server. Then the network capability service request is sent to the radio access network device, and a network capability service response is received from the wireless access network to realize network capability exposure, where the network capability service response is generated by the radio access network device through an internal identifier matching with the external identifier of the network capability service request. Thereby, the network capability exposure can be directly realized at the radio access network side, rather than at the core network side, thus decreasing the network delay and signaling overhead and reducing the consumption of the broadband resources.

An embodiment of the present disclosure provides a method for network capability exposure, which is performed by a core network device.

In some embodiments, by receiving an inquiry request from a radio access network device, where the inquiry request includes an external identifier of an application server and is generated by the radio access network device according to a network capability service request sent by the application server, an inquiry response is generated according to the inquiry request including an internal identifier corresponding to the external identifier. The inquiry response is sent to the radio access network device, such that the radio access network device generates a network capability service response according to the inquiry response and sends the response to the application server. Thereby, network capability exposure can be directly realized on the radio access network side rather than on the core network side, thus decreasing the network delay and the signaling overhead, and reducing the consumption of broadband resources.

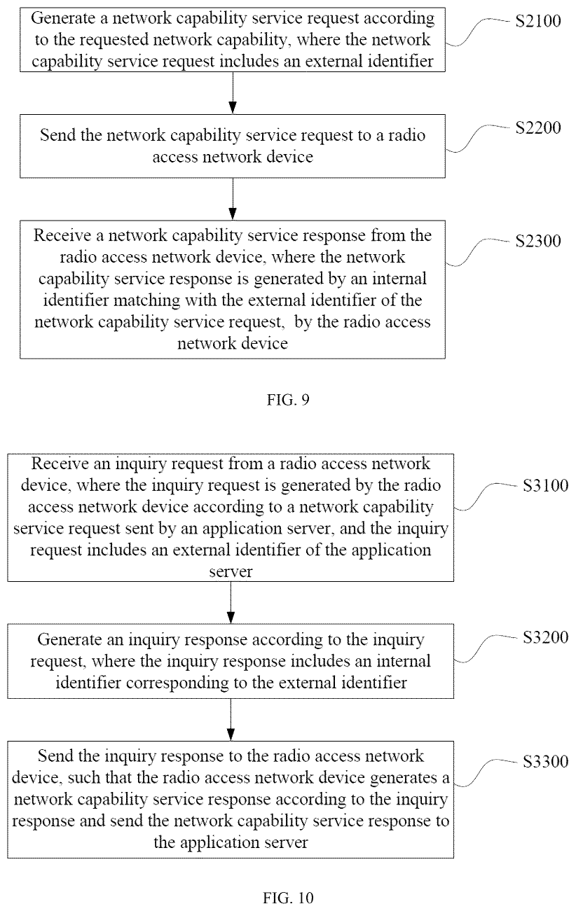

In some embodiments, referring to FIG. 10, the method for network capability exposure performed by a core network device according to an embodiment of the present disclosure includes the following operations.

At S3100, an inquiry request is received from a radio access network device, where the inquiry request is generated by the radio access network device according to a network capability service request sent by an application server, and the inquiry request includes an external identifier of the application server.

At S3200, a query response is generated according to the inquiry request, where the query response includes an internal identifier corresponding to the external identifier.

At S3300, the query response is sent to the radio access network device, such that the radio access network device generates a network capability service response according to the query response and sends the network capability service response to the application server.

The core network device deployed at the core network side receives an inquiry request from the radio access network device deployed at the radio access network side at S3100. The inquiry request is generated by the radio access network device at the radio access network side according to the network capability service request sent by the application server. And the inquiry request includes the external identifier of the application server. It should be noted that the network capability service request, inquiry request and external identifier are discussed in detail in the method for network capability exposure described in the embodiment above, and which are not repeated here.

The core network device generates a query response according to the inquiry request at S3200. The query response includes an internal identifier corresponding to the external identifier. In addition, the query response is discussed in detail in the method for network capability exposure described in the embodiment above, and which is not repeated here.

At S3300, the core network device sends a query response to the radio access network device, such that the radio access network device generates a network capability service response according to the query response, and sends the network capability service response to the application server. The network capability service response, which is generated by the radio access network device according to the query response and is sent to the application server, is discussed in detail in the method for network capability exposure described in the embodiment above, and which is not repeated here.

According to the method for network capability exposure performed by the core network device, an inquiry request is received from a radio access network device, where the inquiry request includes an external identifier of an application server and is generated by the radio access network device according to a network capability service request sent by the application server. A query response, which includes the internal identifier matching with the external identifier, is generated according to the inquiry request. The query response is sent to the radio access network device, such that the radio access network device generates a network capability service response according to the query response and sends the network capability service response to the application server. Thereby, network capability exposure can be directly realized on the radio access network side rather than on the core network side, thus decreasing the network delay and the signaling overhead, and reducing the consumption of broadband resources.

An embodiment of the present disclosure provides a radio access network device.

In some embodiments, the radio access network device includes a first receiving module, a matching module, a first generating module and a first sending module. The radio access network device receives a network capability service request from an application server through the first receiving module, where the network capability service request includes an external identifier of the application server. The matching module performs internal identifier matching according to the external identifier in the network capability service request. The first generating module generates a network capability service response according to the result of the internal identifier matching, and sends the network capability service response to the application server through the first sending module, so as to realize network capability exposure. Thereby, the network capability exposure can be directly realized at the radio access network side, rather than at the core network side, thus decreasing the network delay and signaling overhead and reducing the consumption of the broadband resources.

As shown in FIG. 8, the radio access network device according to an embodiment of the present disclosure includes the following.

A first receiving module, which is configured to receive a network capability service request from an application server, where the network capability service request includes an external identifier.

A matching module, which is configured to perform an internal identifier matching according to the external identifier in the network capability service request.

A first generating module, which is configured to generate a network capability service response according to a result of internal identifier matching.

A first sending module, which is configured to send a network capability service response to the application server.

It should be noted that the radio access network device can be configured to perform the method for network capability exposure performed by the radio access network device described in the embodiment above, with the functions of each module discussed in detail in the method, and which are not repeated here.

According to an embodiment of the present disclosure, a radio access network device is provided.

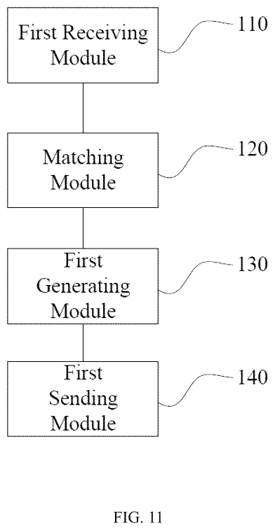

In some embodiments, as shown in FIG. 11, the radio access network device according to an embodiment of the present disclosure includes the following.

A first receiving module 110, which is configured to receive a network capability service request from an application server, where the network capability service request includes an external identifier.

A matching module 120, which is configured to perform an internal identifier matching according to the external identifier in the network capability service request,

A first generating module 130, which is configured to generate a network capability service response according to the result of the internal identifier matching.

A first sending module 140, which is configured to send a network capability service response to the application server.

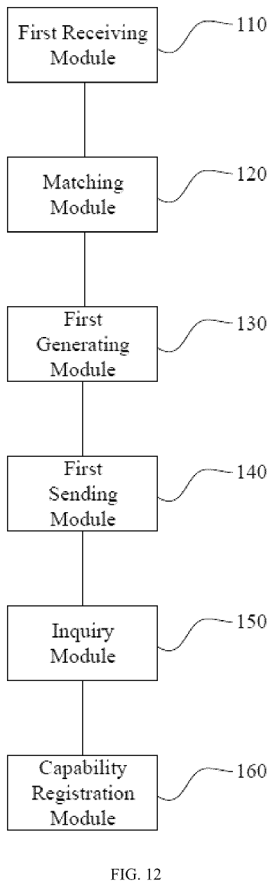

In some embodiments, as shown in FIG. 12, the radio access network device further includes the following.

An inquiry module 150, which is configured to generate an inquiry request according to the network capability service request, send the inquiry request to a core network device, receive a query response generated by the core network device according to the inquiry request, and generate a network capability service response according to the query response.

In some embodiments, as shown in FIG. 12, the radio access network device further includes the following.

A capability registration module 160, which is configured to receive a network capability registration request from a network device, generate a network capability registration response according to the capability registration request, and send the network capability registration response to the network device to confirm the network capability of the network device.

It should be noted that the radio access network device can be configured to perform the method for network capability exposure performed by the radio access network device described in the embodiment above, with the functions of each module discussed in detail in the method, and which are not repeated here.

According to an embodiment of the present disclosure, there is provided a radio access network device. The radio access network device receives a network capability service request from an application server through the first receiving module 110, where the network capability service request includes an external identifier of the application server. The matching module 120 performs an internal identifier matching according to the external identifier in the network capability service request. The first generating module 130 generates a network capability service response according to the result of the internal identifier matching, and sends the network capability service response to the application server through the first sending module 140, so as to realize network capability exposure. Thereby, the network capability exposure can be directly realized at the radio access network side, rather than at the core network side, thus decreasing the network delay and signaling overhead and reducing the consumption of the broadband resources.

An embodiment of the present disclosure provides an application server.

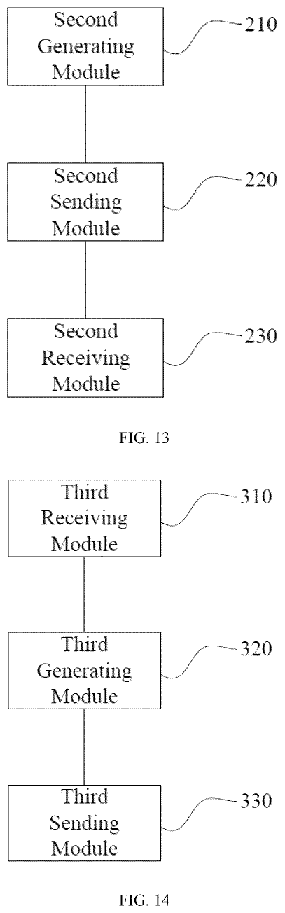

In some embodiments, as shown in FIG. 13, the application server according to an embodiment of the present disclosure includes the following.

A second generating module 210, which is configured to generate a network capability service request according to a requested network capability, and the network capability service request includes an external identifier.

A second sending module 220, which is configured to send a network capability service request to a radio access network device.

A second receiving module 230, which is configured to receive a network capability service response from a radio access network device. The network capability service response is generated by the radio access network device through performing an internal identifier matching according to the external identification in the network capability service request.

It should be noted that the application server can be configured to perform the method for network capability exposure performed by the application server described in the embodiment above, with the functions of each module discussed in detail in the method, and which are not repeated here.

According to an embodiment of the present disclosure, there is provided an application server. The application server generates a network capability service request according to the requested network capability through the second generating module 210, where the network capability service request includes an external identifier of the application server. Then the network capability service request is sent to the radio access network device through the second sending module 220. A network capability service response is received from the wireless access network, through the second receiving module 230, to realize network capability exposure, where the network capability service response is generated by the radio access network device through an internal identifier matching with the external identifier in the network capability service request. Thereby, the network capability exposure can be directly realized at the radio access network side, rather than at the core network side, thus decreasing the network delay and signaling overhead and reducing the consumption of the broadband resources.

An embodiment of the present disclosure provides a core network device.

In some embodiments, as shown in FIG. 14, the core network device according to an embodiment of the present disclosure includes the following.

A third receiving module 310, which is configured to receive an inquiry request from a radio access network device, where the inquiry request is generated by the radio access network device according to a network capability service request sent by an application server, and the inquiry request includes an external identifier of the application server.

A third generating module 320, which is configured to generate a query response according to the inquiry request, where the query response includes an internal identifier corresponding to the external identifier.

A third sending module 330, which is configured to send the query response to the radio access network device, such that the radio access network device generates a network capability service response according to the query response and sends the network capability service response to the application server.

It should be noted that the core network device can be configured to perform the method for network capability exposure performed by the core network device described in the embodiment above, with functions of each module discussed in detail in the method, and which are not repeated here.

The core network device provided according to an embodiment of the present disclosure, is configured to receive an inquiry request from a radio access network device, where the inquiry request includes an external identifier of an application server and is generated by the radio access network device according to a network capability service request sent by the application server. A query response, which includes the internal identifier matching with the external identifier, is generated according to the inquiry request through the third generating module 320. The query response is sent to the radio access network device by the third sending module 330, such that the radio access network device generates a network capability service response according to the query response and sends the network capability service response to the application server. Thereby, network capability exposure can be directly realized on the radio access network side rather than on the core network side, thus decreasing the network delay and the signaling overhead, and reducing the consumption of broadband resources.

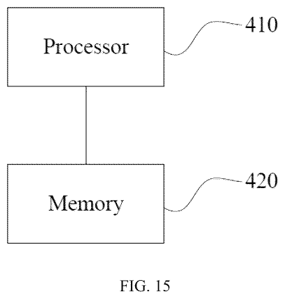

According to an embodiment of the present disclosure, an electronic device is provided. Referring to FIG. 15, the electronic device includes at least one processor 410 and a memory 420 in connection with the at least one processor 410.

The processor 410 is configured to perform the method for network capability exposure performed by a radio access network device, the method for network capability exposure performed by an application server, or the method for network capability exposure performed by a core network device by calling the computer program stored in the memory 420.

As a non-transitory computer-readable storage medium, the memory 420 can be configured to store non-transitory software programs and non-transitory computer-executable programs, such as programs for any one of the methods as described above. The processor 410 executes the non-transitory software program and instructions stored in the memory 420, so as to carry out any one of the methods as described above.

The memory 420 may include a storage program area and a storage data area, where the storage program area may store an operating system and an application program required by at least one function. The storage data area may store the program for the method of any one of the methods as described above. In addition, the memory 420 may include high-speed random-access memory 420 and non-transitory memory 420, such as at least one disk memory device 420, flash memory device, or other non-transitory solid-state memory devices 420. In some embodiments, the memory 420 may include the memory 420 remotely arranged with respect to the processor 410, and the remote memory 420 may be connected to the terminal device through a network. Examples of the above networks include, but are not limited to, the Internet, intranet, local area network, mobile communication network, and combinations thereof.

Non-transitory software programs and instructions associated with any one of the methods for network capability exposure as described above are stored in the memory 420, which when executed by one or more processors 410, causes the processors to carry out any one of the methods as described above.

According to an embodiment of the present disclosure, a computer-readable storage medium is provided. The computer-readable storage medium stores a computer-executable instruction which, when executed by a processor of a computer, causes the processor to carry out any one of the methods as described above.

In some embodiments, the computer-readable storage medium stores computer-executable instructions, which when executed by one or more control processors, e.g., a processor in the electronic device as described above, causes the processors to carry out any one of the methods as described above.

The above-described embodiments are only schematic, in which the units illustrated as separate components may or may not be physically separated, that is, the device may be located in one place or distributed over several network units. Some or all of the modules can be selected according to the practical needs to achieve the purpose of this embodiment.

The above-described device embodiments are only illustrative, in which the units illustrated as separate components may or may not be physically separated, that is, they may be located in one place or distributed over several network units. Some or all of the modules can be selected according to the practical needs to achieve the purpose of this embodiment.

It shall be appreciated by a person having ordinary skills in the art that all or some of the steps and systems disclosed above can be implemented as software, firmware, hardware and their appropriate combinations. Some or all physical components can be implemented as software executed by a processor, such as a central processing unit, a digital signal processor or a microprocessor, or as hardware, or as an integrated circuit, such as an application-specific integrated circuit. Such software can be distributed on computer-readable media, which can include computer storage media (or non-transitory media) and communication media (or transitory media). As is well known to a person having ordinary skills in the art, the term computer storage medium includes volatile and nonvolatile, removable and non-removable medium implemented in any method or technology for storing information such as computer-readable instructions, data structures, program modules or other data. Computer storage mediums include, but are not limited to, RAM, ROM, EEPROM, flash memory or other memory technologies, CD-ROM, digital versatile disks (DVD) or other optical disk storage, magnetic boxes, tapes, magnetic disk storage or other magnetic storage devices, or any other medium that can be used to store desired information and accessible by a computer. Furthermore, it is well known to those having ordinary skills in the art that communication media usually contains computer-readable instructions, data structures, program modules or other data in modulated data signals such as carrier waves or other transmission mechanisms, and can include any information delivery media.

The above is a description of some implementations of the present disclosure, but the present disclosure is not limited to the above-mentioned embodiments, and those having ordinary skills in the art can make various equivalent alternations or variations without violating the scope of the present disclosure, which are included in the scope defined by the claims of the present disclosure.

1. A method for network capability exposure, which is applied to a radio access network device, the method comprising,
receiving a network capability service request from an application server, wherein the network capability service request comprises an external identifier of the application server;
performing an internal identifier matching according to the external identifier in the network capability service request;
generating a network capability service response according to a result of the internal identifier matching; and
sending the network capability service response to the application server.

2. The method of claim 1, wherein, the network capability exposure is associated with a network capability comprising at least one of, location service capability, radio network information service capability, or wireless bandwidth management service capability.

3. The method of claim 1, wherein, the network capability service request further comprises, an application identifier and a network capability identifier, the internal identifier is one of a plurality of internal identifiers, and generating a network capability service response according to a result of the internal identifier matching comprises,
in response to the external identifier matching with one external identifier of the plurality of internal identifiers, generating the network capability service response according to the one internal identifier, the external identifier, the application identifier and the network capability identifier.

4. The method of claim 3, wherein, the one internal identifier is stored in the radio access network device within a preset time.

5. The method of claim 3, wherein,
the external identifier comprises at least one of, UE external IP address, external port number, or UE identifier; and
the internal identifier comprises at least one of, 5G-GUTI, 5G-S-TMSI, 5G-TMSI, AMF UE NGAP ID, UE internal IP address, or internal port number.

6. The method of claim 5, wherein, generating a network capability service response according to a result of the internal identifier matching further comprises,
in response the external identifier failing to match each internal identifier of the plurality of the internal identifiers, generating an inquiry request according to the network capability service request, wherein the inquiry request comprises the external identifier;
sending the inquiry request to a core network device;
receiving a query response generated by the core network device according to the inquiry request, wherein the query response comprises the internal identifier that matches the external identifier; and
generating the network capability service response according to the query response.

7. The method of claim 1, further comprising,
receiving a network capability registration request from a network device;
generating a network capability registration response according to the network capability registration request; and
sending the network capability registration response to the network device to confirm a network capability of the network device.

8. (canceled)

9. A method for network capability exposure, which is applied to a core network device, the method comprising,
receiving an inquiry request from a radio access network device, wherein the inquiry request is generated by the radio access network device according to a network capability service request sent by an application server, and the inquiry request comprises an external identifier of the application server;
generating a query response according to the inquiry request, wherein the query response comprises an internal identifier that matches the external identifier; and
sending the query response to the radio access network device, such that the radio access network device generates a network capability service response according to the query response and sends the network capability service response to the application server.

10. (canceled)

11. (canceled)

12. (canceled)

13. (canceled)

14. (canceled)

15. (canceled)

16. A non-transitory computer-readable storage medium storing a computer-executable instruction which when executed by a processor, causes the processor to carry out:
a method for network capability exposure, which is performed by a radio access network device, the method comprising,
receiving a network capability service request from an application server, wherein the network capability service request comprises an external identifier of the application server;
performing an internal identifier matching according to the external identifier in the network capability service request;
generating a network capability service response according to a result of the internal identifier matching; and
sending the network capability service response to the application server;
or, the computer-executable instruction, when executed by a processor, causes the processor to carry out:
a method for network capability exposure, which is performed by a core network device, the method comprising,
receiving an inquiry request from a radio access network device, wherein the inquiry request is generated by the radio access network device according to a network capability service request sent by an application server, and the inquiry request comprises an external identifier of the application server;
generating a query response according to the inquiry request, wherein the query response comprises an internal identifier that matches the external identifier; and
sending the query response to the radio access network device, such that the radio access network device generates a network capability service response according to the query response and sends the network capability service response to the application server.

17. The method of claim 2, further comprising,
receiving a network capability registration request from a network device;
generating a network capability registration response according to the network capability registration request; and
sending the network capability registration response to the network device to confirm a network capability of the network device.

18. The method of claim 3, further comprising,
receiving a network capability registration request from a network device;
generating a network capability registration response according to the network capability registration request; and
sending the network capability registration response to the network device to confirm a network capability of the network device.

19. The method of claim 4, further comprising,
receiving a network capability registration request from a network device;
generating a network capability registration response according to the network capability registration request; and
sending the network capability registration response to the network device to confirm a network capability of the network device.

20. The method of claim 5, further comprising,
receiving a network capability registration request from a network device;
generating a network capability registration response according to the network capability registration request; and
sending the network capability registration response to the network device to confirm a network capability of the network device.

21. The non-transitory computer-readable storage medium of claim 16, wherein, the network capability exposure is associated with a network capability comprising at least one of, location service capability, radio network information service capability, or wireless bandwidth management service capability.

22. The non-transitory computer-readable storage medium of claim 16, wherein, the network capability service request further comprises, an application identifier and a network capability identifier, the internal identifier is one of a plurality of internal identifiers, and generating a network capability service response according to a result of the internal identifier matching comprises,
in response to the external identifier matching with one external identifier of the plurality of internal identifiers, generating the network capability service response according to the one internal identifier, the external identifier, the application identifier and the network capability identifier.

23. The non-transitory computer-readable storage medium of claim 22, wherein, the one internal identifier is stored in the radio access network device within a preset time.

24. The non-transitory computer-readable storage medium of claim 22, wherein,
the external identifier comprises at least one of, UE external IP address, external port number, or UE identifier; and
the internal identifier comprises at least one of, 5G-GUTI, 5G-S-TMSI, 5G-TMSI, AMF UE NGAP ID, UE internal IP address, or internal port number.

25. The non-transitory computer-readable storage medium of claim 24, wherein, generating a network capability service response according to a result of the internal identifier matching further comprises,
in response the external identifier failing to match each internal identifier of the plurality of the internal identifiers, generating an inquiry request according to the network capability service request, wherein the inquiry request comprises the external identifier;
sending the inquiry request to a core network device;
receiving a query response generated by the core network device according to the inquiry request, wherein the query response comprises the internal identifier that matches the external identifier; and
generating the network capability service response according to the query response.

26. The non-transitory computer-readable storage medium of claim 16, wherein the method performed by the radio access network device further comprises,
receiving a network capability registration request from a network device;
generating a network capability registration response according to the network capability registration request; and
sending the network capability registration response to the network device to confirm a network capability of the network device.
